(19) United States
(12) Patent Application Publication
(10) Pub. No.: US 2004/0063849 A1
(43) Pub. Date: Apr. 1, 2004

(54) Photosolder resist composition

(75) Inventors: Naoya Yabuuchi, Osaka (JP); Minoru Fujita, Osaka (JP); Osamu Namba, Takarazuka-shi (JP); Keiichi Okajima, Osaka (JP)

Correspondence Address: Townsend & Banta, 601 Pennsylvania Avenue, N.W., Suite 900, Washington, DC, 20004, US

(73) Assignee: Nippon Paint Co., Ltd.

(21) Appl. No.: 10/254,530

(22) Filed: Sep. 26, 2002

(51) Int. Cl. C08L 31/00

(52) U.S. Cl. 524/556; 524/523

(57) ABSTRACT

A photosolder resist composition is characterized by containing (A) a resin containing radical polymerization groups and carboxyl groups obtained by adding a cyclic ether group of a cyclic ether group-containing vinyl monomer to a carboxylic group of a radical copolymer containing at least a vinyl aromatic compound and a carboxyl group-containing vinyl monomer as monomer units; (B) an inorganic filler; (C) a photocurable mixture composed of a polyfunctional acrylic monomer (c1), a cyclic ether group-containing compound (c2) and a photopolymerization initiator (c3).

### BACKGROUND OF THE INVENTION

1. Field of the Invention

The present invention relates to a photosolder resist composition which can be alkali developed, and also to a solder resist film formed using the composition.

2. Related Art

As a method for applying a solder to predetermined parts of a printed circuit board, generally employed is a method for forming a solder resist pattern on a printed circuit board. A solder resist is used for applying a solder to the parts where the pattern is not formed and for preventing solder from adhering to the parts where the pattern is formed, and at the same time, is used for protecting the circuit in the parts where the pattern is formed.

Mounting electronic parts on a printed circuit board has recently been densified and a solder resist is required to be fine in its pattern. Hence, a method for patterning a solder resist by photolithographic method has become a general method and for such a purpose, a liquid photosolder resist has been employed.

With respect to such a photosolder resist composition, Japanese Patent No. 2868190 discloses a method in which a modified epoxy resin, obtained by adding acrylic acid to a polyfunctional epoxy resin and adding an acid anhydride to a hydroxyl group produced by the reaction, is used.

However, such a modified epoxy resin has a problem that the resin is inferior in acid resistance and alkaline resistance since the resin contains an ester bond that is easily hydrolyzed in a molecule. Therefore, there occurs a problem that defects are easily caused in a gold plating process to be carried out thereafter. Further since brittleness is high, there is another problem of inferior thermal impact resistance. Furthermore, owing to the epoxy-modified resin, a high cost is also a problem.

Japanese Patent Laid-Open No. 191737 (2000) proposes an acrylic resin-based photosolder resist. However, since the acrylic resin-based resist has high hydrophilicity, the resist has a problem that it is inferior in water resistance and electric properties.

### SUMMARY OF THE INVENTION

The purpose of the invention is to provide a photosolder resist composition that is excellent in gold plating resistance, thermal impact resistance, and electric insulating properties and to provide a solder resist film that is formed using the composition.

The photosolder resist composition of the present invention contains (A) a resin containing radical polymerization groups and carboxyl groups obtained by adding a cyclic ether group of a cyclic ether group-containing vinyl monomer to a carboxylic group of a radical copolymer containing at least a vinyl aromatic compound and a carboxylic group-containing vinyl monomer as monomer units; (B) an inorganic filler; and (C) a photocurable mixture composed of a polyfunctional acrylic monomer (c1), a compound having a cyclic ether group (c2) and a photopolymerization initiator (c3).

The photosolder resist composition of the present invention is excellent in acid resistance and alkaline resistance, and consequently excellent in gold plating resistance and at the same time in thermal impact resistance and electric insulating properties, since the composition contains the above-mentioned resin (A), inorganic filer (B) and photocurable mixture (C).

The resin (A) is preferable to have double bonds of 1.0×10⁻³ to 3.0×10⁻³ mol/g. In addition, the content of the carboxyl group (acid value) is preferably set to 30 to 200 mgKOH/g.

The ratio of the carboxyl group in the resin (A) and the cyclic ether group in the photocurable mixture (C), that is, in the compound (c2), is preferably set to 1.3/0.7 to 0.7/1.3 by mole.

Further, the solder resist composition of the present invention may further contain a coloring pigment.

The content of the inorganic filler (B) is preferably set to 5 to 75 parts by weight in 100 parts by weight of solid content of the entire photosolder resist composition of the present invention.

Further, in the present invention, the resin (A) may be neutralized by a base and made water-soluble.

The solder resist film of the present invention is obtained by applying the photosolder resist composition of the present invention to a substrate, drying at 50 to 90° C., exposing by activation energy beam, removing and developing non-exposed parts with an alkaline washing solution, and heating and curing the photocured parts at 140 to 170° C.

### DETAILED DESCRIPTION OF THE INVENTION

Hereinafter, detailed description will be given respectively for the resin (A), i.e. the first component, the inorganic filler (B), i.e. the second component, and the photocurable mixture (C), i.e. the third component, of the photosolder resist composition of the present invention.

(A) The Resin Containing a Radical Polymerization Group and a Carboxyl Group

The first component contained in the photosolder resist composition of the present invention is a resin containing a radical polymerization group and a carboxyl group, and can be obtained by ring-opening addition of a cyclic ether group of a cyclic ether group-containing vinyl monomer to a carboxylic group of a radical copolymer containing at least a vinyl aromatic compound and a vinyl monomer containing a carboxylic group as monomer units. The content of the vinyl aromatic compound contained in the resin (A) is preferably set to 10 to 50% by weight, more preferably, 15 to 35% by weight. If less than 10% by weight, the tack property and the thermal resistance may become insufficient and if more than 50% by weight, the brittleness may become too high.

Examples of the vinyl aromatic compound include: styrene, p-methylstyrene, m-methylstyrene, vinylnaphthalene and the like, and among these, in particular, styrene and p-methylstyrene are more preferably used.

Examples of the carboxyl group-containing vinyl monomer include: acrylic acid, methacrylic acid and the like. With respect to an example of the cyclic ether group-containing vinyl monomer, glycidyl methacrylate is typical one and 3,4-epoxycyclohexyl methacrylate is also usable, disclosed in Japanese Patent Laid-Open No. 191737(2000). However, from a viewpoint of an addition reactivity, the material cost and the like, glycidyl methacrylate is especially preferable to be used.

The resin (A) containing a radical polymerization group and a carboxyl group contains at least one radical polymerization group and carboxyl group in one molecule, in which the double bonds are preferably set to 1.0×10⁻³ to 3.0 to×10⁻³ mol/g, and the content of the carboxyl group is preferably set to 30 to 200 mgKOH/g. If the double bonds are less than 1.0×10⁻³ mol/g, the photocurable property of the obtained resist may become insufficient so that there is possibility to result in deterioration of adhesion and thermal resistance at the time of development, and if they are more than 3.0×10⁻³ mol/g, not only the film strength may become brittle but also the resolution property may be deteriorated. Further, if the content of the carboxyl group is less than 30 mgKOH/g, the alkaline development property may be deteriorated, and if it is more than 200 mgKOH/g, even the exposed parts may be dissolved. The double bonds are further preferably set to 1.5×10⁻³ to 2.7×10⁻³ mol/g and the content of the carboxy group is further preferably set to 70 to 120 mgKOH/g.

The number average molecular weight of the resin (A) is preferably set to 2,000 to 40,000. If it is less than 2,000, the heat resistance of the obtained resist may becomes insufficient, and if it is more than 40,000, the viscosity may become too high and there sometimes occurs a problem on the workability at the time of producing the composition.

In the present invention, a base may be added to the resin (A) to neutralize the carboxyl group so as to use the resin (A) as an aqueous solution. The above-mentioned base is not particularly limited and well-known neutralization agents for carboxylic group, for example, inorganic substances such as sodium hydroxide, potassium hydroxide, and lithium hydroxide; and amine compounds such as triethylamine and dimethylethanolamine are usable. The amount of the above-mentioned base is properly determined corresponding to the molecular weight of the resin (A) and the content of the carboxyl group and may be set to a proper amount to make the resin (A) water soluble and, for example, the amount may be set to be sufficient to neutralize 30 to 200% (0.3 to 2 mole) of that of carboxyl group.

(B) Inorganic Filler

The second component contained in the photosolder resist composition is an inorganic filler. The inorganic filler is used to improve the heat resistance of the resist and usable are well known substances such as barium sulfate, finely powdered silicon carbide, amorphous silica, talc, mica and the like. Additionally, the above-mentioned inorganic filler includes a well-known fire retardant. Incidentally, the above-mentioned inorganic filler can be dispersed by a known method in the presence of the resin (A).

The amount of the above-mentioned inorganic filler is determined as a ratio to the entire solid content of the photosolder resist composition of the invention. The ratio will be described later in the description of the photosolder resist composition.

(C) Photocurable Mixture

The third component contained in the photosolder resist composition of the invention is a photocurable mixture of a polyfunctional acrylic monomer (c1), a compound containing cyclic ether group (c2), and a photopolymerization initiator (c3).

<Polyfunctional Acrylic Monomer (c1)>

The above-mentioned polyfunctional acrylic monomer (c1) may be any compound having 2 or more polymerization groups (for example, acryloyl group or methacryloyl group) in one molecule, and it is possible to make photocuring for patterning by including the polyfunctional acrylic monomer (c1).

Practical examples of the above-mentioned polyfunctional acrylic monomer (c1) are pentaerythritol triacrylate, dipentaerythritol pentacrylate, polyethylene glycol diacrylate, polypropylene glycol diacrylate, trimethylolpropane triacrylate, pentaerythritol tetracrylate, dipentaerythritol hexacrylate and methacrylates corresponding to the above-mentioned acrylates. These may be used solely or in combination of two or more of them.

<Cyclic Ether Group-Containing Compound (c2)>

The above-mentioned compound containing cyclic ether group (c2) is to be heated to cause curing reaction with the carboxyl group of the resist composition (mainly of the resin (A)). Examples of those which the cyclic ether group is glycidyl are well-known compounds such as bisphenol type, phenol novolak type, cresol novolak type and the like. A variety of compounds are commercialized as those having alicyclic epoxy group, for example, Celloxide series, Epoleed series, Cyclomer series and polymers of these which are sold by Daicel Chem. Ind., Ltd. Further, as those having oxetane group, Aron Oxetane series are sold by Toagosei Chemical Industry Co., Ltd. Among these, those having 2 or more alicyclic epoxy groups or oxetane groups in one molecule are preferably used, and those having 3 or more of these are more preferably used.

<Photopolymerization Initiator (c3)>

With respect to the above-mentioned photopolymerization initiator (c3), well-known compounds may be used. Practical examples are benzoin and bensoin alkyl ethers such as benzoin, benzoin methyl ether, benzoin ethyl ether, benzoin propyl ether and the like; acetophenones such as acetophenone, 2,2-dimethoxy-2-phenylacetophenone, 2,2-diethoxy-2-phenylacetophenone, 1,1-dichloroacetophenone and the like; aminoacetophenones such as 2-methyl-l-[4-(methylthio) phenyl]-2-morpholinopropanone-1,2-benzyl-2-dimethylamino-1-(4-morpholinophenyl)-butanone-1, N,N-dimethylaminoacetophenone and the like; anthraquinones such as 2-methylanthraquinone, 2-ethylanthraquinone, 2-tert-butylanthraquinone, 1-chloroanthraquinone and the like; thioxanthones such as 2,4-dimethylthioxanthone, 2,4-diethylthioxanthone, 2-chlorothioxanthone, 2,4-diisopropylthioxanthone and the like; ketals such as acetophenone dimethyl ketal, benzyl dimethyl ketal and the like; benzophenones or xanthones such as benzophenone, 4,4′-bisdiethylaminobenzophenone and the like; and phosphine oxide such as 2,4,6-trimethylbenzoyldiphenylphosphine oxide. These compounds may be used solely or as a mixture of two or more of them. Further, a tertiary amine such as triethanolamine and a photoinitiator promotor such as ethyl dimethylaminobenzoate may be added to use.

The weight ratios of the above-mentioned polyfunctional acrylic monomer (c1), compound containing cyclic ether group (c2), and photopolymerization initiator (c3) in the photocurable mixture contained in the photosolder resist composition of the invention are determined as the ratios to the entire solid content contained in the photosolder resist composition of the invention. The ratios will be described later in the description of the photosolder resist composition.

Further, the above-mentioned photocurable mixture may further contain a compound containing an amino group such as dicyanediamide, and melamine and blocked isocyanate and the like which are reacted with a cyclic ether group, other than the above-mentioned components.

Photosolder Resist Composition

The photosolder resist composition of the present invention contains (A) a resin containing radical polymerization groups and carboxyl groups obtained by adding a cyclic ether group of a cyclic ether group-containing vinyl monomer to a carboxylic group of a radical copolymer containing at least a vinyl aromatic compound and a carboxylic group-containing vinyl monomer as monomer units; (B) an inorganic filler; and (C) a photocurable mixture of a polyfunctional acrylic monomer (c1), a compound containing a cyclic ether group (c2) and a photopolymerization initiator (c3).

The photosolder resist composition of the present invention can be obtained by mixing the above-mentioned components by a method well known by skilled in the art. At this time, the ratios of the respective components preferably satisfy the following conditions in order to improve the capabilities of the resist composition and the resist obtained from the composition.

First, the ratio of the carboxyl groups of the resin (A) to the cyclic ether groups of the photocurable mixture (C) is preferably set to 1.3/0.7 to 0.7/1.3 by mole ratio. If the ratio is out of the range, the cross-linking degree may not be increased, thereby resulting in insufficient heat resistance. Moreover, the ratio is more preferably set to 1.15/0.85 to 0.85/1.15 by mole ratio.

Next, the inorganic filler (B) is preferably set in a ratio of 5 to 75 parts by weight to 100 parts by weight of the entire solid content of the photosolder resist composition of the present invention. If less than 5 parts by weight, in some cases, the effect of preventing the heat resistance and curing shrinkage becomes insufficient and if more than 75 parts by weight, in some cases, the development property is deteriorated. The ratio is more preferably set to 15 to 60 parts by weight.

Further, the polyfunctional acrylic monomer (c1) contained in the photocurable mixture (C) is preferably set in a ratio of 2.0 to 15.0 parts by weight to 100 parts by weight of the entire solid content of the photosolder resist composition of the present invention. If less than 2.0 parts by weight, in some cases, the photocurable property becomes insufficient and if more than 15.0 parts by weight, in some cases, the cold heat impact resistance is deteriorated.

On the other hand, the photopolymerization initiator (c3) contained in the photocurable mixture (C) is preferably set in a ratio of 0.5 to 7.5 parts by weight to 100 parts by weight of the entire solid content of the photosolder resist composition of the present invention. If less than 0.5 parts by weight, in some cases, the photocurable property becomes insufficient and if more than 7.5 parts by weight, in some cases, the hardness of a film is possibly lowered since the double-bond chains become too short at the time of photocuring. The ratio is more preferably 1.0 to 5.0 parts by weight.

Moreover, the compound containing the cyclic ether group (c2) contained in the photocurable mixture (C) is preferably set in a ratio of 5.0 to 15 parts by weight to 100 parts by weight of the entire solid content of the photosolder resist composition of the present invention. If less than 5.0 parts by weight, in some cases, the heat resistance becomes insufficient owing to low curing density and if more than 15 parts by weight, in some cases, the cured film becomes brittle. Further, the ratio is more preferably 7.5 to 12.0 parts by weight.

The photosolder resist composition of the present invention may contain an internal solvent other than the above-mentioned components based on necessity. The solvent is used as an assisting agent for making a film even and capable of dissolving the oil components among the above-mentioned components therein and has a boiling point of 120 to 250° C., preferably 135 to 200° C., and practical examples are propylene glycol diacetate, dipropylene glycol monomethyl ether, propylene glycol monomethyl ether acetate and the like. In the case of using the internal solvent, it is preferably set in 100 parts by weight or lower, more preferably in 25 parts by weight or lower, to 100 parts by weight of the entire solid content of the photosolder resist composition of the present invention.

Further, the photosolder resist composition of the present invention may contain a coloring pigment. With respect to the coloring pigment, well-known pigments such as phthalocyanine copper, phthalocyanine chloride, Quinacridone Red and the like are usable. In the case of including a coloring pigment, the pigment is preferably set in a ratio of 0.02 to 4.0 parts by weight to 100 parts by weight of the entire solid content of the photosolder resist composition of the invention. If less than 0.02 parts by weight, in some cases, the coloring property is insufficient and if more than 4.0 parts by weight, in some cases, the film is possibly parted at the time of development owing to deterioration of the photocurable property. The ratio is more preferably 0.05 to 1.0 parts by weight.

The photosolder resist composition of the present invention can be obtained by mixing the above-mentioned components and generally, at first, the resin (A) is produced and then the inorganic filler (B) and, if necessary, a coloring pigment are added to the resin and then the respective components of the photocurable mixture (C) and an internal solvent, if necessary, are added and the resulting mixture is made uniform. In form of products, two-liquid mixture type ones consisting of a mixture of the resin (A) and the inorganic filler (B) and the photocurable mixture (C), and one-liquid type ones containing all of the resin (A), the inorganic filler (B) and the photocurable mixture (C) are possible.

The photosolder resist composition of the present invention may be used while being emulsified by neutralizing the resin (A) with a base and making the resin water soluble, removing the solvent contained in the resin based on necessity, adding the inorganic filler (B) and a coloring pigment if necessary and dispersing them, and after than, adding the respective components of the photocurable mixture (C) and an internal solvent based on necessity. Since the water-soluble photosolder resist composition can be used while using a lessened amount of solvent, it is extremely advantageous from the viewpoint of scarce malodor emission and good working environments. The particle diameter of the emulsion of the photosolder resist composition of the invention obtained in such a manner is preferably set to 0.1 to 10.0 μm and more preferably set to 0.3 to 2.0 μm in the surface area average particle diameter. If it is smaller than 0.1 μm, it may be difficult to produce and if it is larger than 10.0 μm, in some cases, the precipitation or flocculation of particles takes place.

The ratio of the solid content of the photosolder resist composition of the present invention is preferably set to 30 to 90% by weight, more preferably, 40 to 85% by weight. If it is less than 30% by weight, the economical efficiency may be slight and if it is more than 90% by weight, it may become difficult to produce since the viscosity becomes too high.

The photosolder resist composition of the present invention is applied to a base material such as a substrate, and generally dried at 50 to 90° C. After drying, activation energy beam such as UV ray is radiated to carry out exposure and the non-exposed parts are developed and removed with an alkaline washing solution and further the photocured parts are heated, for example, at 140 to 170° C. to promote thermal curing and obtain a solder resist film.

### DESCRIPTION OF THE PREFERRED EMBODIMENTS

### Production Example 1

Production of (A) Resin Containing Radical Polymerization Groups and Carboxylic Groups

A separable flask of 2 L capacity and equipped with a reflux pipe, a temperature adjusting apparatus and a stirring blade was loaded with 760 parts by weight of carbitol acetate and the temperature was adjusted at 120° C. To the flask, a mixed solution of 200 parts by weight of styrene, 300 parts by weight of methacrylic acid and 7.5 parts by weight of tert-butylperoxy-2-ethylhexanoate was dropped for 2 hours and reaction was continued further for another one hour. Then, a mixed solution of 50 parts by weight of carbitol acetate and 0.75 parts by weight of tert-butylperoxy-2-ethylhexanoate was dropped for 30 minutes, reaction was continued further for another one hour, and the temperature of the reaction was increased to 130° C. and kept for 2 hours. To the resulting mixture, a mixture of 310 parts by weight of glycidyl methacrylate, 1.5 parts by weight of benzyldimethylamine and 1.5 parts by weight of hydroquinone was added and reaction was continued for 8 hours under airflow. The obtained product had the weight average molecular weight of 14,200 and the acid value of 92.6 mgKOH/g. The quantity of the double bonds was 2.76×10⁻³ mol/g.

### Production Example 2

Production of (A) Resin Containing Radical Polymerization Groups and Carboxylic Groups

A separable flask of 2 L capacity and equipped with a reflux pipe, a temperature adjusting apparatus and a stirring blade was loaded with 760 parts by weight of carbitol acetate and the temperature was adjusted at 120° C. To the flask, a mixed solution of 160 parts by weight of p-methylstyrene, 40 parts by weight of methylmethacrylate, 300 parts by weight of methacrylic acid and 7.5 parts by weight of tert-butylperoxy-2-ethylhexanoate was dropped for 2 hours and reaction was continued for another one hour. Then, a mixed solution of 50 parts by weight of carbitol acetate and 0.75 parts by weight of tert-butylperoxy-2-ethylhexanoate was dropped for 30 minutes, reaction was continued further for another one hour, and the temperature of the reaction was increased to 130° C. and kept for 2 hours. To the resulting mixture, a mixture of 310 parts by weight of glycidyl methacrylate, 1.5 parts by weight of benzyldimethylamine and 1.5 parts by weight of hydroquinone was added and reaction was continued for 8 hours under airflow. The obtained product had the weight average molecular weight of 15500 and the acid value of 92.4 mgKOH/g. The quantity of the double bonds was 2.79×10⁻³ mol/g.

### Production Example 3

Production of (A) Resin Containing Radical Polymerization Groups and Carboxylic Groups

A separable flask of 2 L capacity and equipped with a reflux pipe, a temperature adjusting apparatus and a stirring blade was loaded with 760 parts by weight of propylene glycol monomethylether, and the temperature was adjusted at 110° C. To the flask, a mixed solution of 170 parts by weight of styrene, 30 parts by weight of t-butylmethacrylate, 300 parts by weight of methacrylic acid, and 17.5 parts by weight of tert-butylperoxy-2-ethylhexanoate was dropped for 2 hours and reaction was continued for another one hour. Then, a mixed solution of 50 parts by weight of propylene glycol monomethylether and 0.75 parts by weight of tert-butylperoxy-2-ethylhexanoate was dropped for 30 minutes, reaction was continued further for another one hour, and the temperature of the reaction was increased to 120° C. and kept for 3 hours. To the resulting mixture, a mixture of 300 parts by weight of glycidyl methacrylate, 1.5 parts by weight of benzyldimethylamine and 1.5 parts by weight of hydroquinone was added and reaction was continued for8hours under airflow. The obtained product had the weight average molecular weight of 14700 and the acid value of 96.9 mgKOH/g. The quantity of the double bonds was 2.61×10⁻³ mol/g.

### Production Example 4

Production of (A) Water-Soluble Resin

To 200 g of the resin solution of the production example 3, 20 g of triethylamine and 600 g of ion exchanged water were added and stirred for 1 hour and some of the solvent and water were removed by reduced pressure to obtain an aqueous solution containing 30.0% by weight of solid content.

### Production Example 5

Production of Epoxy Resin (Conventional Example) Containing Radical Polymerization Groups and Carboxylic Groups

A separable flask of 2 L capacity and equipped with a reflux pipe, a temperature adjusting apparatus, and a stirring blade was loaded with 400 parts by weight of EOCN-104S (cresol novolak type epoxy resin produced by Nippon Kayaku Co., Ltd.), 740.5 parts by weight of carbitol acetate, 0.50 parts by weight of hydroquinone and 1.20 parts by weight of triphenylphosphine, and the temperature was adjusted at 90° C. under airflow. To the flask, 148.3 parts by weight of acrylic acid was dropped for 30 minutes and further, reaction was continued for 24 hours. At that time, the acid value was around zero. Then, 192.2 parts by weight of tetrahydrophthalic acid anhydride was added and reaction was continued further for 10 hours. The obtained product had the acid value of 93.2 mgKOH/g.

### Production Example 6

Production of Epoxy Resin (Conventional Example) Containing Radical Polymerization Groups and Carboxylic Groups

A separable flask of 2 L capacity and equipped with a reflux pipe, a temperature adjusting apparatus, and a stirring blade was loaded with 400 parts by weight of EOCN-104S (cresol novolak type epoxy resin produced by Nippon Kayaku Co., Ltd.), 740.5 parts by weight of propylene glycol monomethylether, 0.50 parts by weight of hydroquinone and 1.20 parts by weight of triphenylphosphine, and the temperature was adjusted at 90° C. under airflow. To the flask, 148.3 parts by weight of acrylic acid was dropped for 30 minutes and reaction was further continued for 24 hours. At that time, the acid value was around zero. Then, 192.2 parts by weight of tetrahydrophthalic acid anhydride was added and reaction was continued further for 10 hours. The obtained product had the acid value of 93.9mgKOH/g.

### Production Example 7

Production of Water-Soluble Resin (Conventional Example)

To 200 g of the resin solution of the production example 6, 20 g of triethylamine and 600 g of ion exchanged water were added and stirred for 1 hour and some of the solvent and water were removed by reduced pressure to obtain an aqueous solution containing 30.0% by weight of solid content.

### Production Example 8

Production of Epoxy Resin (Reference Example) Containing Radical Polymerization Groups and Carboxylic Groups

Production was carried out in the same manner as the production example 1, except that methyl methacrylate was used in place of styrene. The obtained product had the weight average molecular weight of 17,600 and the acid value of 94.0 mgKOH/g.

### Production Example 9

Production of (C) Photocurable Mixture

A photocurable mixture was produced by mixing 150 parts by weight of trimethylol propane trimethacrylate and 40 parts by weight of pentaerythritol tetracrylate as the polyfunctional acrylic monomer (c1), 22.0 parts by weight of Irgacure 907 (a photopolymerization initiator, produced by Ciba-Geigy Corp.) and 8.0 parts by weight of diethylthioxanthone as the photopolymerization initiator (c3), and 180 parts by weight of EHPE 3150 (a polyfunctional epoxy compound, produced by Daicel Chem. Ind., Ltd.) as the compound containing cyclic ether group (c2), and 100 parts by weight of propylene glycol monomethyl ether acetate as an internal solvent.

### Production Example 10

Production of Pigment Dispersion

The resin solution (50% bywweight of solid content) of the production example 1 of 360 parts by weight, B-34 (barium sulfate, produced by Sakai Chemical Industry Co., Ltd.) of 298 parts by weight and Phthalocyanine Blue of 2.0 parts by weight were mixed by a roll mill.

### Production Example 11

Production of Pigment Dispersion

The resin solution (50% by weight of solid content) of the production example 2 of 360 parts by weight, B-34 (barium sulfate, produced by Sakai Chemical Industry Co., Ltd.) of 298 parts by weight and Phthalocyanine Blue of 2.0 parts by weight were mixed by a roll mill.

### Production Example 12

Production of Pigment Dispersion

The aqueous resin solution (30% by weight of solid content) of the production example 4 of 600 parts by weight, B-34 (barium sulfate, produced by Sakai Chemical Industry Co., Ltd.) of 298 parts by weight, Phthalocyanine Blue of 2.0 parts by weight and ion exchanged water of 60 parts by weight were mixed by a Dinomill.

### Production Example 13

Production of Pigment Dispersion

The resin solution (50% by weight of solid content) of the production example 5 of 360 parts by weight, B-34 (barium sulfate, produced by Sakai Chemical Industry Co., Ltd.) of 298 parts by weight and Phthalocyanine Blue of 2.0 parts by weight were mixed by a roll mill.

### Production Example 14

Production of Pigment Dispersion

The aqueous resin solution (30% by weight of solid content) of the production example 7 of 600 parts by weight, B-34 (barium sulfate, produced by Sakai Chemical Industry Co., Ltd.) of 298 parts by weight, Phthalocyanine Blue of 2.0 parts by weight and ion exchanged water of 60 parts by weight were mixed by a Dinomill.

### Production Example 15

Production of Pigment Dispersion

The resin solution (50% by weight of solid content) of the production example 8 of 360 parts by weight, B-34 (barium sulfate, produced by Sakai Chemical Industry Co., Ltd.) of 298 parts by weight and Phthalocyanine Blue of 2.0 parts by weight were mixed by a roll mill.

### EXAMPLE 1

Production of Photosolder Resist Composition No. 1

The solution of the photocurable mixture (C) obtained in production example 9 of 50 parts by weight and the pigment dispersion obtained in production example 10 of 220 parts by weight were mixed.

### EXAMPLE 2

Production of Photosolder Resist Composition No. 2

The solution of the photocurable mixture (C) obtained in production example 9 of 50 parts by weight and the pigment dispersion obtained in production example 11 of 220 parts by weight were mixed.

### EXAMPLE 3

Production of Water-Soluble Photosolder Resist Composition No. 1

The solution of the photocurable mixture (C) obtained in production example 9 of 50 parts by weight and the pigment dispersion obtained in production example 12 of 320 parts by weight were mixed.

### Comparative Example 1

Production of Photosolder Resist Composition No. 3

The solution of the photocurable mixture (C) obtained in production example 9 of 50 parts by weight and the pigment dispersion obtained in production example 13 of 220 parts by weight were mixed.

### Comparative Example 2

Production of Water-Soluble Photosolder Resist Composition No. 2

The solution of the photocurable mixture (C) obtained in production example 9 of 50 parts by weight and the pigment dispersion obtained in production example 14 of 320 parts by weight were mixed.

### Comparative Example 3

Production of Photosolder Resist Composition No. 4

The solution of the photocurable mixture (C) obtained in production example 9 of 50 parts by weight and the pigment dispersion obtained in production example 15 of 220 parts by weight were mixed.

The mixing ratios of the above-mentioned examples 1 to 3 and comparative examples 1 to 3 are collectively shown in Table 1. Incidentally, Table 1 shows the mole ratio of [carboxyl groups in the resin (A) /cyclic ether groups of the photocurable mixture (C)] in the respective photosolder resist compositions and the content of the inorganic fillers (by parts by weight in 100 parts by weight of the solid content of the respective photosolder resist compositions) in the respective photosolder resist compositions.

TABLE 1

| | | | | Carboxyl | |
|---|---|---|---|---|---|
| | | | | Groups of the | Content |
| | | | | Resin (A)/ | of |
| | | | Photo- | Cyclic Ether | Inorganic |
| | | | curable | Groups of the | Filler |
| | Pigment Dispersion | | Mixture | Photocurable | (Parts by |
| | (A) + (B) | (A) | (C) | Mixture (C) | Weight) |
| Ex. 1 | Production | Production | Production | 49/51 | 50 |
| | Ex. 10 | Ex. 1 | Ex. 9 | | |
| Ex. 2 | Production | Production | Production | 49/51 | 50 |
| | Ex. 11 | Ex. 2 | Ex. 9 | | |
| Ex. 3 | Production | Production | Production | 50/50 | 50 |
| | Ex. 12 | Ex. 4 | Ex. 9 | | |
| Comp. | Production | Production | Production | 49/51 | 50 |
| Ex. 1 | Ex. 13 | Ex. 5 | Ex. 9 | | |
| Comp. | Production | Production | Production | 49/51 | 50 |
| Ex. 2 | Ex. 14 | Ex. 7 | Ex. 9 | | |
| Comp. | Production | Production | Production | 50/50 | 50 |
| Ex. 3 | Ex. 15 | Ex. 8 | Ex. 9 | | |

<Evaluation Test>

Each of the photosolder resist compositions of the examples 1 to 3 and the comparative examples 1 to 3 was applied to a substrate bearing a patterned copper foil for evaluation of the development property, the solder heat resistance, the gold plating resistance and thermal impact resistance, and to a combteeth-type electrode coupon of IPCB-25 for evaluation of the electric insulating property, by screen printing in the film thickness of 23 to 27 μm, respectively, and dried at 80° C. for 20 minutes. After drying, being covered with a negative film, each resulting film was exposed with 200 mj/cm² and developed with an aqueous sodium carbonate solution at 1 kg/cm² spraying pressure and then cured by heating at 150° C. Each resulting resist film was evaluated according to the following evaluation standards. Further, the storage stability of the pigment dispersions was also evaluated.

Development property: evaluation was performed by eye observation based on the degree of elimination of lines of 50/50 (μm) of the obtained copper foil-bearing substrate.

Solder heat resistance: evaluation was performed by eye observation based on the state of blistering and peeling of the resist layer after a rosin type flux was applied to the obtained copper foil-bearing substrate and then the substrate was immersed in a solder tank preliminarily set at 260° C. and then the flux was washed out with a denatured alcohol. The evaluation standards were shown as follows:

\mathring{∘}: no peeling was observed even after repeating the immersion for 10 seconds 6 times or more:

◯: no peeling was observed even after repeating the immersion for 10 seconds 3 to 5 times:

Δ: peeling was slightly observed if the immersion for 10 seconds was repeated 3 times or more: and

×: blistering and peeling were observed if the immersion for 10 seconds was carried out one time.

Electric insulating property: the volume intrinsic resistance was measured according to ASTM D 257.

Gold plating resistance: the evaluation was performed by tape peeling after plating while the plating thickness being adjusted to be 0.1 μm.

Cold heat impact resistance: a tape peeling test was carried out after repeating 200 cycles of heating at the maximum temperature 125° C. and cooling at the minimum temperature −65° C. for 10-minutes retention duration for each temperature.

Storage stability of pigment dispersions: the appearance was checked after storage for 2 weeks at 40° C. The evaluation results are shown in Table 2.

TABLE 2

| | Example | | | Comparative Example | | |
|---|---|---|---|---|---|---|
| | 1 | 2 | 3 | 1 | 2 | 3 |
| Development | Excellent | Excellent | Excellent | Excellent | Insufficient | Inferior |
| Property | | | | | in Develop- | Adhesion |
| (50/50 L/S) | | | | | ment | Strength |
| Volume | 10¹⁶ | 10¹⁶ | 10¹⁶ | 10¹⁶ | 10¹⁵ | 10¹² |
| Intrinsic | | | | | | |
| Resistance | | | | | | |
| (Ω · cm) | | | | | | |
| Solder Heating | ⊚ | ⊚ | ⊚ | Δ | Δ | X |
| Resistance | | | | | | |
| Gold Plating | Excellent | Excellent | Excellent | Partially | Partially | Significant |
| Resistance | | | | Peeled | Peeled | Peeling |
| (Tape Peeling) | | | | | | |
| Thermal | Excellent | Excellent | Excellent | Partially | Partially | Significant |
| Impact | | | | Peeled | Peeled | Peeling |
| Resistance | | | | | | |
| (Tape Peeling) | | | | | | |
| Storage | Excellent | Excellent | Excellent | Excellent | Occurrence | Excellent |
| Stability of | | | | | of Pigment | |
| Pigment | | | | | Agglomera- | |
| Dispersions | | | | | tion | |

As being made clear from the results shown in Table 2, the photosolder resist compositions of the examples 1 to 3 in accordance with the invention were found excellent in the development property, having high volume intrinsic resistance, and excellent in the electric insulating property. Further, they were found excellent also in the solder heat resistance, gold plating resistance, and thermal impact resistance. Furthermore, the storage stability of the pigment dispersions was found excellent.

According to the present invention, it becomes possible to obtain a photosolder resist composition that is excellent in properties such as gold plating resistance, thermal impact resistance, and electric insulating property.

What is claimed is:

1. A photosolder resist composition containing (A) a resin containing radical polymerization groups and carboxyl groups obtained by adding a cyclic ether group of a cyclic ether group-containing vinyl monomer to a carboxylic group of a radical copolymer containing at least a vinyl aromatic compound and a carboxylic group-containing vinyl monomer as monomer units; (B) an inorganic filler; and (C) a photocurable mixture composed of a polyfunctional acrylic monomer (c1), a cyclic ether group-containing compound (c2) and a photopolymerization initiator (c3).

2. The photosolder resist composition according to claim 1, wherein said resin (A) has double bonds of 1.0×10⁻³ to 3.0×10⁻³ mol/g and the content of the carboxyl group of 30 to 200 mgKOH/g.

3. The photosolder resist composition according to claim 1, wherein the ratio of the carboxyl group in said resin (A) and the cyclic ether group in said photocurable mixture (C) is set to 1.3/0.7 to 0.7/1.3 by mole ratio.

4. The photosolder resist composition according to claim 1, further containing a coloring pigment.

5. The photosolder resist composition according to claim 1, wherein the content of said inorganic filler (B) is set to 5 to 75 parts by weight in 100 parts by weight of solid content of the photosolder resist composition.

6. The aqueous emulsion type photosolder resist composition according to claim 1, wherein said resin (A) is neutralized by a base and made water-soluble.

7. A solder resist film obtained by applying the photosolder resist composition according to claim 1 to a substrate, drying at 50 to 90° C., exposing by activation energy beam, removing and developing non-exposed parts with an alkaline washing solution, and heating and curing the photocured parts at 140 to 170° C.
